(19) United States
(12) Patent Application Publication
(10) Pub. No.: US 2008/0255984 A1
(43) Pub. Date: Oct. 16, 2008

(54) RESOURCE PROVISION COORDINATION SYSTEM AND METHOD

(75) Inventor: Colin Millstone, St. Louis, MO (US)

Correspondence Address: HARNESS, DICKEY & PIERCE, P.L.C., P.O. BOX 828, BLOOMFIELD HILLS, MI, 48303, US

(73) Assignee: Bitness Corp., St. Louis, MO (US)

(21) Appl. No.: 11/734,076

(22) Filed: Apr. 11, 2007

(51) Int. Cl. G06Q 40/00

(52) U.S. Cl. 705/38

(57) ABSTRACT

A resource provision coordination system includes an enrollment module enrolling members who wish to transact with their clientele, including obtaining promises of members to pay fees in exchange for membership, approving members for financing of credit lines, and creating member accounts having the credit lines associated therewith in computer readable memory. A datastore of member offerings includes resources supplied by engaged resource providers and offered to the members at least one of exclusively or according to terms not available to non-members. A coordinated resource provision environment provides community and a la carte resources at least to the members. The community resources include at least base offerings supplied to members by at least a resource provision coordinator in exchange for the fees. The a la carte resources include at least the member offerings.

### FIELD

The present disclosure generally relates to methods of doing business, and relates in particular to providing of resources to small businesses, startups, and entrepreneurs in a coordinated fashion.

### BACKGROUND

The statements in this section merely provide background information related to the present disclosure and may not constitute prior art.

The fastest growing market in the United States is small businesses. Franchises have a much greater success rate than independent businesses. There are an estimated 25.8 million small businesses in the United States that: (a) have generated 60 to 80 percent of net new jobs annually over the last decade; (b) employ 50 percent of the country's private sector workforce; represent 97 percent of all the exporters of goods; (c) represent 99.7 percent of all employer firms; and (d) generate a majority of the innovations that come from United States companies.

Most small businesses fail. For example, in recent times, there were 671,800 new businesses, and 544,800 business closures. Two-thirds of new employer firms survive at least two years, and about 44% survive at least four. Findings do not differ greatly across industry sectors.

General trends indicate that self-employment rates and types and behaviors of self-employed persons vary. For example, the number of self-employed workers in June 2005 fell 3.1 percent or 303,000 from the month before, Labor Department data showed. Also, self employment tends to fall as the economy grows. That's especially true among laid-off workers who start tiny companies after failing to find work in slow times. Further, during 1979-2003, self-employment increased: (a) 33 percent for women; (b) 37 percent for African Americans; (c) 15 percent for Latinos; (d) 10 for White Americans; and (e) 2.5 percent for men. Yet further, small business owners go for advice to: (a) individual mentors at a rate of 52 percent; (b) social networks at a rate of 51 percent; (c) trade associations at a rate of 44 percent; (d) business advisors at a rate of 36 percent; (e) the Internet at a rate of 31 percent; and (f) Chambers of Commerce at a rate of 27 percent.

Women-owned businesses serve as an apt example of new and growing small businesses and their needs. For example, women represent more than ⅓ of all people involved in entrepreneurial activity. Additionally, between 1997 and 2002, women-owned firms grew by 19.8 percent while all U.S. firms grew by seven percent. Also, women-owned firms accounted for 6.5 percent of total employment in U.S. firms in 2002 and 4.2 percent of total receipts. Further, the number of women-owned firms continues to grow at twice the rate of all U.S. firms (23 percent vs. 9 percent). Yet further, there are an estimated 10 million women-owned, privately-held U.S. businesses. Therefore, it is significant that the greatest challenge for women-owned firms is access to capital, credit and equity, because women start businesses for both lifestyle and financial reasons, and many run businesses from home to keep overhead low. It is further significant that women are more likely to seek business advice—69 percent women vs. 47 percent men

Minority-owned businesses also serve as an apt example of new and growing small businesses and their needs. In particular, black-owned businesses are the fastest growing segment, up 45 percent between 1997-2002. Moreover, revenues generated by the nation's 1.2 million black-owned businesses rose 25 percent between 1997 and 2002 to $88.8 billion in 2002. Also, the number of U.S. businesses with Hispanic owners grew at three times the national average from 1997 to 2002 to 1.6 million businesses in 2002, a 31 percent increase from five years earlier.

Seniors in business also serve as an apt example of new and growing small businesses and their needs. For example, entrepreneurship among seniors is growing. Also, in 2002, the rate of self-employment for the workforce was 10.2 percent (13.8 million workers), but the rate for workers aged 50 was 16.4 percent (5.6 million workers). Thus, although those age 50 made up 25 percent of the workforce, they comprised 40 of the self-employed. Accordingly, it is significant that solo business formation in the future will be driven by people who take early retirement or whose jobs just disappear.

There are currently a number of hot markets in which small businesses can find a niche. For example, there is a need for eBay drop-off sites. Also, there is a need for search engine optimization and Internet marketing services. Additionally, there is a need for performance apparel businesses. Further, there is a need for niche health and fitness businesses. Further, there is a need for technology security consulting. Yet further, there is a need for services/products for the Hispanic-market.

Given the rate of attribution for small businesses, and the existence of unfulfilled market niches, it is evident that a need exists for a way to assist small businesses, and/or a way to motivate small business owners to assist one another. One type of circumstance in which people with common interests come together and collaborate, for seemingly altruistic reasons, exists in the case of the virtual community. Typically, the virtual community exists for the purpose of developing a knowledge base. Since knowledge is one of the things small business owners tend to seek out, the virtual community seems to be of interest in determining how to address the needs of small business owners.

A community is a basic element of an organized society, and the Internet has brought about the growth of Virtual Communities. Virtual Communities are by design non-touch. Some examples of Virtual Communities include: (1) BBS or Internet Forum: The WELL, GEnie, Dead Runners Society; (2) Blog: LiveJournal, Xanga, MySpace, Facebook, Blogger; (3) Webcomic: UserFriendly, Penny Arcade, Sluggy Freelance, Ctrl+Alt+Del; (4) Virtual world/city: LucasFilm's Habitat, Secondlife, Millsberry, Red Light Centr; (5) IM: ICQ, Yahoo! Messenger, Windows Live Messenger, AIM; (6) IRC/EFNet; MMORPG: Everquest, Ultima Online, RuneScape, World of Warcraft, Silk Road Online; (7) MOO: LambdaMOO; (8) MUD/MUSH: TinyMUD; (9) P2P: Kazaa, Morpheus, Napster, Limewire; (10) USENET; (11) Wiki: Wikipedia, WikiWikiWeb, Wetpaint, PBWiki; and (12) WWW: eBay, GeoCities, Slashdot, Digg.

A virtual community or online community is a group of people that may or may not primarily or initially communicate or interact via the Internet. Online communities have also become a supplemental form of communication between people who know each other in real life. The dawn of the “information age” found groups communicating electronically rather than face to face. A “Computer-mediated community” (CMC) uses social software to regulate the activities of participants. An online community such as one responsible for collaboratively producing open source software is sometimes called a development community. Significant socio-technical change has resulted from the proliferation of Internet-based social networks.

Today, virtual community or online community can be used loosely for a variety of social groups interacting via the Internet. It does not necessarily mean that there is a strong bond among the members, although Rheingold mentions that virtual communities form “when people carry on public discussions long enough, with sufficient human feeling, to form webs of personal relationships.” An email distribution list may have hundreds of members and the communication which takes place may be merely informational (questions and answers are posted), but members may remain relative strangers and the membership turnover rate could be high. This is in line with the liberal use of the term community.

The term virtual community is attributed to the book of the same title by Howard Rheingold, published in 1993. The book discussed his adventures on The WELL and onward into a range of computer-mediated communication and social groups. The technologies included Usenet, MUDs (Multi-User Dungeon) and their derivatives MUSHes and MOOs, IRC (Internet Relay Chat), chat rooms and electronic mailing lists; the World Wide Web as we know it today was not yet used by many people. Rheingold pointed out the potential benefits for personal psychological well-being, as well as for society at large, of belonging to such a group.

Virtual communities may synthesize Web 2.0 technologies with the community, and therefore have been described as Community 2.0, although strong community bonds have been forged online since the early days of USENET. Virtual communities depend upon social interaction and exchange between users online. This emphasizes the reciprocity element of the unwritten social contract between community members. Web 2.0 is essentially characterized by virtual communities such as Flickr, Facebook, and Del.icio.us.

Different virtual communities have different levels of interaction and participation among their members. This interaction ranges from adding comments or tags to a blog or message board post to competing against other people in online video games such as MMORPGs. Not unlike traditional social groups or clubs, virtual communities often divide themselves into cliques or even separate to form new communities. Author Amy Jo Kim points out a potential difference between traditional structured online communities (message boards, chat rooms, etc), and more individual-centric, bottom-up social tools (blogs, instant messaging buddy lists), and suggests the latter are gaining in popularity.

There have been a number of researchers investigating motivation and desire in virtual communities. Studies show that over the long term users gain a greater insight into the material that is being discussed and a sense of connection to the world at large.

Peter Kollock (1999) researched motivations for contributing to online communities. In “The Economies of Online Cooperation: Gifts and Public Goods in Cyberspace”, he outlines three motivations (Kollock:227) that do not rely on altruistic behavior on the part of the contributor: (1) Anticipated Reciprocity; (2) Increased Recognition; and (3) sense of efficacy. Recognition is important to online contributors such that, in general, individuals want recognition for their contributions; some have called this Egoboo. Kollock outlines the importance of reputation online: “Rheingold (1993) in his discussion of the WELL (an early online community) lists the desire for prestige as one of the key motivations of individuals' contributions to the group. To the extent this is the concern of an individual, contributions will likely be increased to the degree that the contribution is visible to the community as a whole and to the extent there is some recognition of the person's contributions. . . . the powerful effects of seemingly trivial markers of recognition (e.g. being designated as an “official helper”) has been commented on in a number of online communities . . . ” Regarding sense of efficacy, there is another, implicit motivation which Mark Smith mentions in his 1992 thesis: Voices from the WELL: The Logic of the Virtual Commons: Communion, as Smith terms it, or “sense of community” as it is referred to in social psychology.

Regarding anticipated reciprocity, a person is motivated to contribute valuable information to the group in the expectation that one will receive useful help and information in return. Indeed, there is evidence that active participants in online communities get more responses faster to questions than unknown participants (Kollock 178), and this effect is related to increased recognition. One of the key ingredients of encouraging a reputation is to allow contributors to be known or not to be anonymous. The following example, from Meyers (1989) study of the computer underground illustrates the power of reputation. When involved in illegal activities, computer hackers must protect their personal identities with pseudonyms. If hackers use the same nicknames repeatedly, this can help the authorities to trace them. Nevertheless, hackers are reluctant to change their pseudonyms regularly because the status associated with a particular nickname would be lost.

The link between anticipated reciprocity and increased reputation is additionally illustrated in that profiles and reputation are clearly evident in online communities today. Amazon.com is a case in point, as all contributors are allowed to create profiles about themselves and as their contributions are measured by the community, their reputation increases. Myspace.com encourages elaborate profiles for members where they can share all kinds of information about themselves including what music they like, their heroes, etc. In addition to this, many communities give incentives for contributing. For example, many forums award participants points for posting. Members can spend these points in a virtual store. eBay is an example of an online community where reputation is very important because it is used to measure the trustworthiness of someone you potentially will do business with. With eBay, participants have the opportunity to rate their experiences with one another. This rating has an effect on the reputation score, which in turn is linked to the sense of efficacy.

The sense of efficacy is important because individuals may contribute valuable information because the act results in a sense of efficacy, that is, a sense that they have had some effect on than environment. There is well-developed research literature that has shown how important a sense of efficacy is (e.g. Bandura 1995), and making regular and high quality contributions to a group can help individuals believe that they have an impact on the group and support their own self-image as an efficacious person. Wikipedia is a prime example of an online community that gives contributors a sense of efficacy. Wikipedia is an online encyclopedia which uses online software to enable anyone to create new articles and change any article in the encyclopedia. The changes participants make are immediate, obvious, and available to the world.

It is envisioned that the sense of community is a strong motivator because people, in general, are fairly social beings and it is motivating to many people to be responded to directly for their contributions. Most online communities enable this direct response by allowing people to reply back to contributions (i.e. many Blogs allow comments from readers, you can reply back to forum posts, etc). Again, using Amazon.com, other users can rate whether your product review was helpful or not. Granted, there is some overlap between increasing reputation and gaining a sense of community, however, it seems safe to say that there is some overlapping areas between all four motivators.

Some design guidelines for a virtual community can be summarized as follows: (a) trusting a participant's input makes it easy for participants to contribute to a knowledge base and makes the input accessible to others, resulting in a sense of efficacy for participants; (b) enabling the knowledge base to evolve as processes and concepts change results in a sense of efficacy for participants; (c) allowing other members to be known and get credit by measuring their contributions results in increased reputation, anticipated reciprocity, and sense of community for participants; and (d) allowing other members to measure and respond to contributions results in a sense of community and increased reputation for participants.

What is needed a way for small businesses, startups, and entrepreneurs to have their needs met in a way that engages and rewards them in a fashion similar to that of a virtual community. The present teachings fulfill this need.

### SUMMARY

A resource provision coordination system includes an enrollment module enrolling members across industries who wish to transact with their clientele, including obtaining promises of members to pay fees in exchange for membership, approving members for financing of credit lines, and creating member accounts having the credit lines associated therewith in computer readable memory. A datastore of member offerings includes resources supplied by engaged resource providers and offered to the members at least one of exclusively or according to terms not available to non-members. A coordinated resource provision environment provides community and a la carte resources at least to the members. The community resources include at least base offerings supplied to members at least by a resource provision coordinator in exchange for the fees. The a la carte resources include at least the member offerings.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a block diagram illustrating a resource provision coordination system;

FIG. 2 is an entity relationship diagram illustrating interactions between a coordinator, resource providers, members, and the public;

FIG. 3 is a block diagram illustrating member-centric interaction processes between resource providers and members;

FIG. 4 is a block diagram illustrating a coordinated resource provision environment;

FIG. 5 is a plan view illustrating a coordinator facility of the coordinated resource provision environment.

FIG. 6 is a flow diagram illustrating a resource provision coordination method.

FIG. 7 is a flow diagram illustrating interaction between members and a resource provision coordinator.

FIG. 8 is a flow diagram illustrating a member enrollment process.

FIG. 9 is a flow diagram illustrating interaction between resource providers and a resource provision coordinator.

FIG. 10 is a flow diagram illustrating a resource provider engagement process.

### DETAILED DESCRIPTION

The following description is merely exemplary in nature and is not intended to limit the present disclosure, application, or uses.

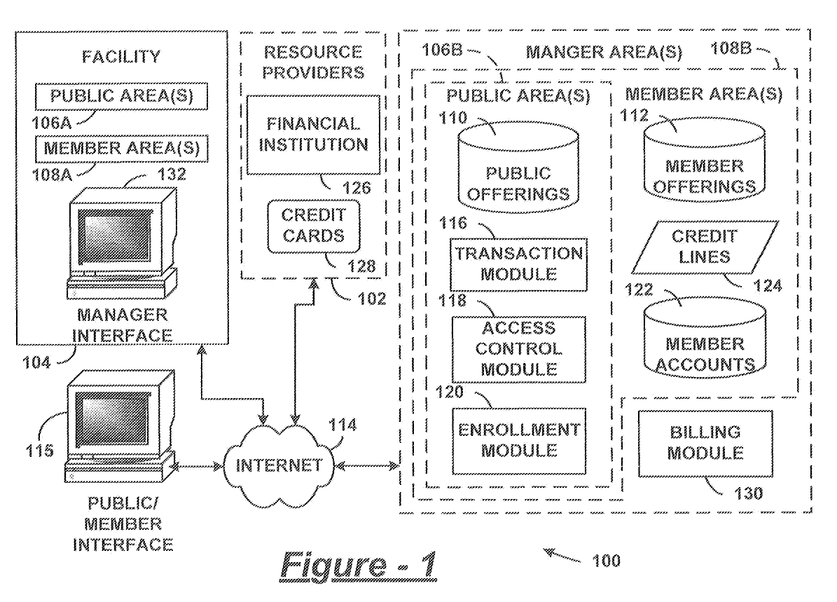

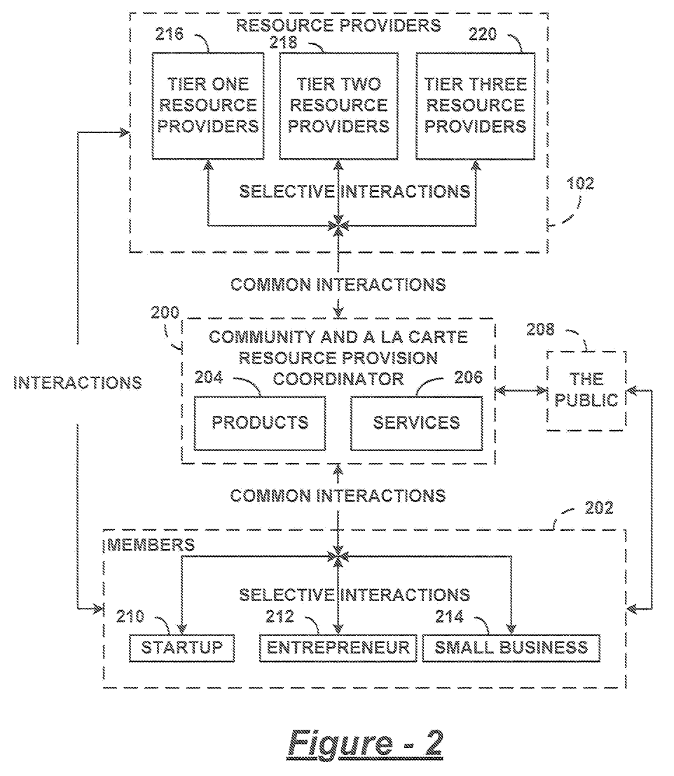

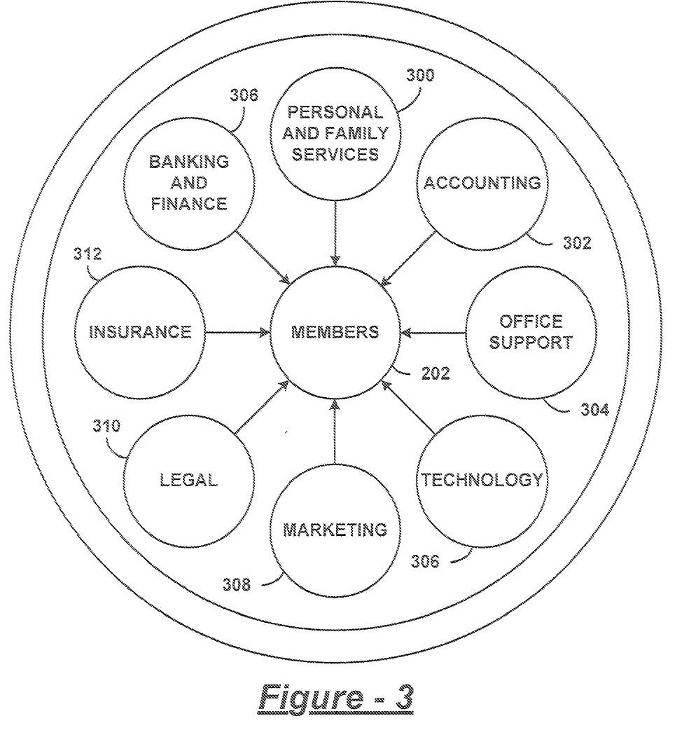

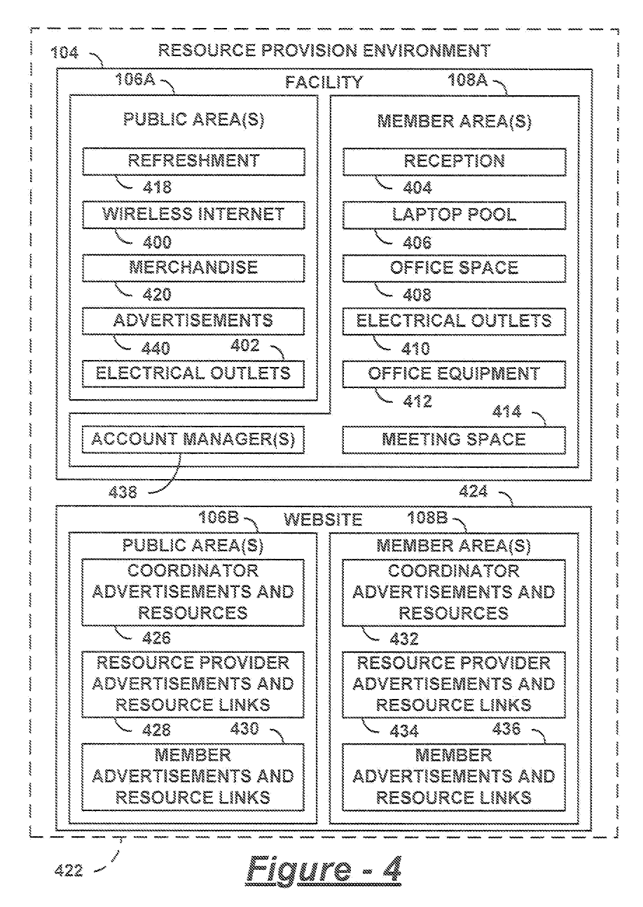

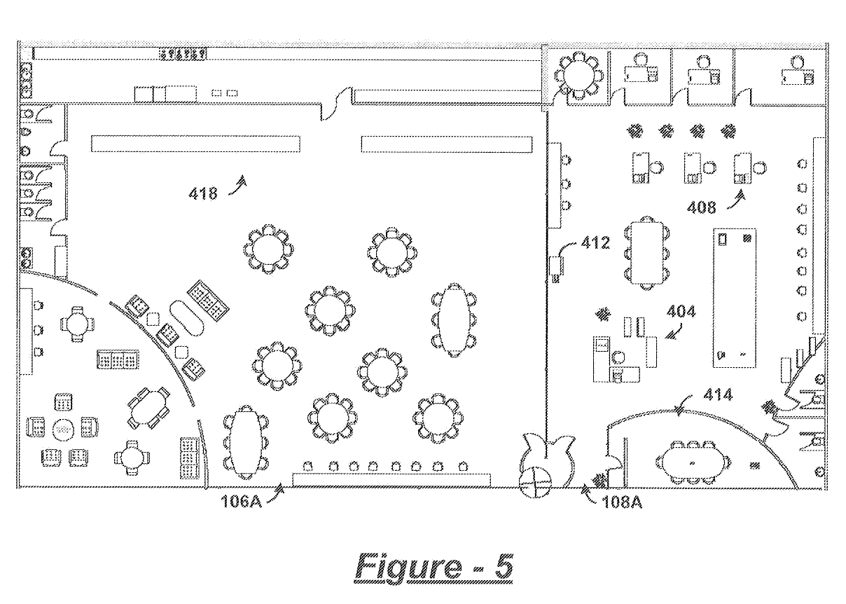

Starting with FIGS. 1-5 and referring generally thereto, a resource coordination provision system 100 operates in the roll of a resource provision coordinator 200. The coordinator 200 interacts with members 202 and resource providers 102 in order to facilitate provision of resources, such as products 204 and services 206, to the members 202. The resources can be supplied by the resource providers 102, by the members 202, and/or by the coordinator 200.

The coordinator 200, the resource providers 102, and the members 202 collaborate to see to the needs of the members 202. Types of resources that are supplied to the members 202 can include personal and family services 300, accounting services and software products 302, office support 304, technological products, services, and support 306, marketing products and services 308, legal services 310, insurance coverage 312, and banking and finance products and services 314. Details regarding some offerings for some embodiments are provided below in tables 1-x.

TABLE 1
Offering: Personal & Family Services

| | | Coor- | Resource | | |
|---|---|---|---|---|---|
| ID | Offering | dinator | provider | Member | Notes |
| 1 | Automotive | | ✓ | ✓ | Broker, |
| | Purchase | | | | Manufacturer, |
| | | | | | Dealership |
| 2 | Automotive | | ✓ | ✓ | Mechanic, auto |
| | Repair | | | | glass, oil change |
| 3 | Babysitting | | | ✓ | |
| 4 | Child Care | | ✓ | ✓ | |
| 5 | Chiropractic | | ✓ | | |
| | Services | | | | |
| 6 | Counseling | | ✓ | ✓ | |
| | Services | | | | |
| 7 | Day Care | | ✓ | ✓ | |
| 8 | Elder Care | | ✓ | ✓ | |
| 9 | Exercise | | ✓ | ✓ | |
| | Equipment | | | | |
| 10 | Health Clubs/ | | ✓ | ✓ | |
| | Gyms | | | | |
| 11 | Home Builders | | ✓ | ✓ | |
| 12 | Home | | | ✓ | Maid, Plumber, |
| | Maintenance | | | | Electrician, |
| | | | | | HVAC, Carpenter, |
| | | | | | Lawn care, etc. |
| 13 | House Sitting | | | ✓ | |
| 14 | Massage | | | ✓ | |
| 15 | Motorcycle | | ✓ | ✓ | Manufacturer, |
| | Purchase | | | | Dealership |
| 16 | Nanny Services | | | ✓ | |
| 17 | Nutrition | | | ✓ | |
| 18 | Personal | | | ✓ | |
| | Training | | | | |
| 19 | Pet Care | | ✓ | ✓ | Pet food, dog |
| | | | | | walking, pooper |
| | | | | | scooping, |
| | | | | | grooming |
| 20 | Ready-made | | | ✓ | |
| | meals | | | | |
| 21 | Veterinary | | | ✓ | |
| | Services | | | | |

TABLE 2
Offering: Accounting

| | | | Resource | | |
|---|---|---|---|---|---|
| ID | Offering | Coordinator | provider | Member | Notes |
| 1 | A/P | ✓ | ✓ | ✓ | Independent |
| | | | | | accountants, |
| | | | | | outsourced |
| | | | | | svcs, software |
| | | | | | package |
| 2 | A/R | ✓ | ✓ | ✓ | Independent |
| | | | | | accountants, |
| | | | | | outsourced |
| | | | | | svcs, software |
| | | | | | package |
| 3 | Bookkeeping | ✓ | ✓ | ✓ | Independent |
| | | | | | accountants, |
| | | | | | outsourced |
| | | | | | svcs, software |
| | | | | | package |
| 4 | Counseling & | ✓ | ✓ | ✓ | Independent |
| | Setup | | | | accountants, |
| | | | | | outsourced |
| | | | | | svcs |
| 5 | Financial | ✓ | ✓ | ✓ | Independent |
| | Reporting | | | | accountants, |
| | | | | | outsourced |
| | | | | | svcs, software |
| | | | | | package |
| 6 | Payroll | | ✓ | ✓ | Independent |
| | | | | | accountants, |
| | | | | | outsourced |
| | | | | | svcs, software |
| | | | | | package |
| 7 | Tax | | ✓ | ✓ | Independent |
| | Preparation | | | | accountants, |
| | | | | | outsourced |
| | | | | | svcs, software |
| | | | | | package |

TABLE 3
Offering: Office Support

| | | Co- | Resource | | |
|---|---|---|---|---|---|
| ID | Offering | ordinator | provider | Member | Notes |
| 1 | Administrative | ✓ | | ✓ | |
| | Services | | | | |
| 2 | Catering | ✓ | | ✓ | |
| 3 | Event Planning | | | ✓ | |
| 4 | Hotel Resort, B & B | | ✓ | ✓ | |
| 5 | Internet | | ✓ | | |
| | Connectivity | | | | |
| 6 | Meeting Rooms | ✓ | | | |
| 7 | Notary | ✓ | | | |
| 8 | Office Interiors | ✓ | | ✓ | |
| 9 | Office Space | ✓ | | ✓ | |
| 10 | Office Supplies | | ✓ | | |
| 11 | Purchase Office | | ✓ | ✓ | fax, copier, |
| | Equipment | | | | printer, pc, |
| | | | | | phone |
| 12 | Purchase Software | | ✓ | | |
| 13 | Real Estate Lease | | | ✓ | |
| 14 | Real Estate | | | ✓ | |
| | Purchase | | | | |
| 15 | Receptionist | ✓ | | | |
| 16 | Restaurant | ✓ | | | |
| | Reservations | | | | |
| 17 | Restaurants | | | ✓ | |
| 18 | Staffing | | ✓ | ✓ | |
| 19 | Telephony Services | | ✓ | | “1–800” |
| | | | | | phone |
| | | | | | number, |
| | | | | | conference |
| | | | | | lines, video |
| | | | | | conference, |
| | | | | | voicemail |
| 20 | Travel Services | | ✓ | ✓ | |
| 21 | Use of Office | ✓ | | | fax, copier, |
| | Equipment | | | | printer, pc |
| 22 | Voicemail | ✓ | ✓ | | |
| 23 | Wireless Devices & | | ✓ | | |
| | Services | | | | |

TABLE 4
Offering: Technology

| | | | Resource | | |
|---|---|---|---|---|---|
| ID | Offering | Coordinator | provider | Member | Notes |
| 1 | Collaboration Tools | | ✓ | | |
| 2 | Content | ✓ | ✓ | ✓ | |
| | Management | | | | |
| | Support | | | | |
| 3 | Content | | ✓ | | |
| | Management Tools | | | | |
| 4 | Customer Support | ✓ | ✓ | ✓ | |
| 5 | eCommerce | | ✓ | ✓ | |
| 6 | eMail Hosting | | ✓ | | |
| 7 | eMail Setup & | ✓ | ✓ | ✓ | |
| | Support | | | | |
| 8 | Help Desk | ✓ | ✓ | | |
| 9 | Networking | | ✓ | ✓ | |
| 10 | PC Support | ✓ | ✓ | ✓ | |
| 11 | POS | | ✓ | ✓ | |
| 12 | Programming/ | ✓ | | ✓ | |
| | Custom | | | | |
| | Development | | | | |
| 13 | Security | | ✓ | ✓ | |
| 14 | Software Selection | ✓ | | ✓ | |
| 15 | Tech Evaluation | ✓ | | ✓ | |
| 16 | Web Domain Setup | ✓ | ✓ | ✓ | |
| 17 | Website | ✓ | | ✓ | |
| | Development | | | | |
| 18 | Website Hosting | | ✓ | | |
| 19 | Website Support | ✓ | ✓ | ✓ | |

TABLE 5
Offering: Marketing

| | | | Resource | | |
|---|---|---|---|---|---|
| ID | Offering | Coordinator | provider | Member | Notes |
| 1 | Advertising Design | ✓ | | ✓ | |
| 2 | Advertising | ✓ | | ✓ | |
| | Placement & | | | | |
| | Purchase | | | | |
| 3 | Creative Design | ✓ | | ✓ | |
| 4 | Audience | ✓ | | ✓ | |
| | Segmentation & | | | | |
| | Management | | | | |
| 5 | Brand Design & | ✓ | | ✓ | |
| | Management | | | | |
| 6 | Campaign/ | ✓ | ✓ | ✓ | |
| | Program Design & | | | | |
| | Implementation | | | | |
| 7 | Copy Writing | ✓ | | ✓ | |
| 8 | Coupon | ✓ | ✓ | ✓ | |
| | Administration & | | | | |
| | Fulfillment | | | | |
| 9 | CRM | ✓ | | ✓ | |
| 10 | Customer | ✓ | | ✓ | |
| | Acquisition | | | | |
| 11 | Customer | ✓ | | ✓ | |
| | Retention | | | | |
| 12 | Graphics Design | ✓ | | ✓ | |
| 13 | Logo Design | ✓ | | ✓ | |
| 14 | Loyalty Programs | | ✓ | ✓ | |
| 15 | Photography | | | ✓ | |
| 16 | Planning & Strategy | ✓ | ✓ | ✓ | |
| 17 | Print Production | | ✓ | ✓ | |
| 18 | Promotional Items | | ✓ | | |
| 19 | Promotions | ✓ | | ✓ | |
| 20 | Public Relations | ✓ | | ✓ | |

TABLE 6
Offering: Legal

| | | | Resource | | |
|---|---|---|---|---|---|
| ID | Offering | Coordinator | provider | Member | Notes |
| 1 | Advisory Services | ✓ | ✓ | ✓ | |
| 2 | Contract | ✓ | ✓ | ✓ | |
| | Development & | | | | |
| | Review | | | | |
| 3 | EIN Setup | ✓ | ✓ | ✓ | |
| 4 | Estate Planning | ✓ | ✓ | ✓ | |
| 5 | Estimated Tax | ✓ | ✓ | ✓ | |
| | Management | | | | |
| 6 | Legal Entity | ✓ | ✓ | ✓ | |
| | Determination & | | | | |
| | Setup | | | | |
| 7 | Legal Forms | ✓ | ✓ | ✓ | |
| 8 | Litigation | | ✓ | ✓ | |
| 9 | Patent | | ✓ | ✓ | |
| 10 | State Registration | ✓ | ✓ | ✓ | |
| 11 | Tax Planning | ✓ | ✓ | ✓ | |
| 12 | Trademark | ✓ | ✓ | ✓ | |

TABLE 7
Offering: Insurance

| | | | | | |
|---|---|---|---|---|---|
| | | | Resource | | |
| ID | Offering | Coordinator | provider | Member | Notes |

| | | |
|---|---|---|
| 1 | Business | ✓ |
| | Insurance | |
| 2 | Health Insurance | ✓ |
| 3 | Prescription Drug | ✓ |
| | Services | |
| 4 | Dental Insurance | ✓ |
| 5 | Life Insurance | ✓ |
| 6 | Disability | ✓ |
| | Insurance | |
| 7 | Car Insurance | ✓ |
| 8 | Motorcycle | ✓ |
| | Insurance | |
| 9 | Homeowners | ✓ |
| | Insurance | |
| 10 | Renters | ✓ |
| | Insurance | |

TABLE 8
Offering: Finance

| | | | | | |
|---|---|---|---|---|---|
| | | | Resource | | |
| ID | Offering | Coordinator | provider | Member | Notes |

| | | |
|---|---|---|
| 1 | Business | ✓ |
| | Financing | |
| 2 | Mortgage | ✓ |
| | Financing | |
| 3 | Vehicle | ✓ |
| | Financing | |
| 4 | Letter of | ✓ |
| | Credit | |
| 5 | Bank | ✓ |
| | Accounts | |
| 6 | Credit | ✓ |
| | Cards | |
| 7 | Safe | ✓ |
| | Deposit | |
| 8 | Venture | ✓ |
| | Capital | |

Two categories of resources can be community resources and a la carte resources. Some of the community resources can be community resources that are enjoyed by the members 202 and by the general public 208. An example of such community resources can be free wireless Internet access 400 and electrical outlets 402 supplied at least in a public area 106A at one or more facilities 104 supplied and maintained by the coordinator 200. Some of the community resources can be community resources that are selectively supplied only to the members 202; these are base offerings. An example of base offerings can be a secured office environment supplied in a member area 108A at one or more coordinator facilities 104 and contents thereof. Such contents can include reception 404, a laptop pool 406, office space 408, electrical outlets 410, office equipment 412, meeting space 414, and services and expertise of coordinator staff, especially account managers 438. It is envisioned that some of these base offerings, such as use of a laptop pool, can be enjoyed by members in the public area 106A as well as the member area 108A. Also, it should understood that, in some embodiments, enjoyment of the base offerings is covered entirely by membership fees, so that the base offerings can be enjoyed by members without requiring additional expenditure. Thus, a discount on coffee is not an example of a base offering, but rather of an a la carte resource.

Some of the a la carte resources can be presented to the members 202 and to the public 208; these are public offerings 110. At the facility 104, an example of such public offerings 110 can be refreshments 128 presented for purchase by all in the public area 106A accessible by members 202 and by the public 208. It is envisioned that these refreshments 128 and other public offerings 110 can be provided by the coordinator 200 or by resource providers 102 in a cafe environment. Moreover, members 202, in offering their products and/or services to the public 208 and to other members 202, can contribute to the public offerings 110.

Others of these resources can be selectively presented only for members 202 to purchase; these are member offerings 112. Examples of member offerings 112 can be accounting software supplied by one of the resource providers 102. Another example of member offerings 112 can be apparel bearing a logo of the coordinator 200. Yet another example of member offerings 112 can be any of the public offerings that are available to members on terms not available to the public 208, such as at a discount, with expedited handling, or some other experience. It should be readily understood that member offerings 112 can be presented for purchase only in member areas 108A, or presented for purchase by members 202 only with other merchandise 420 in public areas 106A. It is alternatively or additionally envisioned that some or all apparel bearing a coordinator logo can be part of public offering 110. Similarly, it is envisioned that some members 202 can offer some or all of their products or services only to other members 202 or on terms not available to the public, in which case they contribute to the member offerings 112.

The coordinator 200 provides a coordinated resource provision environment 422 at which the members 202 receive at least some of the resources. The facility 104 is an example of such an environment 422 or portion thereof. The environment 422 can alternatively or additionally be online by way of the Internet or other communications system 114. Thus, the environment 422 can include a website 424 accessible via a public/member interface 115 running, for example, as a client on computer processors of the public or of members.

As the facility 104 can have public areas 106A and member areas 108A, so the website 424 can have public areas 106B and member areas 108B in which public offerings 110 and member offerings 112 are selectively made available to the members 202 and to the public 208. For example, advertisements, merchandise, and services 426 of the coordinator 200 can be viewed and purchased directly in public areas 106B as public offerings 110. Transaction module 116 can be employed to accomplish electronic transactions by members 202 and by the public 208 ordering such products and services. Also, it is envisioned that advertisements 428 for public offerings 110 by resource providers 102 can be viewed in the public areas 106B, with links to websites of the resource providers 102 supplied. It is further envisioned that advertisements 430 for products and services of members with links to member websites can be accessed in the public areas 106B.

Members accessing public areas 106B can interface with access control module 118 in order to gain access to contents of member areas 108B, including member offerings 112. Nonmembers who wish to access the member offerings 112 can interface with enrollment module 120 in order to become members 202. It is envisioned that public offerings 110 and member offerings 112 can have filters installed online that filter the offerings by locale of a user interface, such as interface 115. Thus, IP addresses of members 202 and/or the public 202 can determine which offerings of resource providers are presented, which locations 104 or base offerings of the coordinator 200 are presented, and which products and/or services of members are presented by the interface 115 having the IP address.

Members 202 can be supplied with member accounts 122 having credit lines 124 associated therewith that are issued by one of resource providers 102, such as a financial institution 126 that can issue credit cards 128 to members 202 upon successful application for membership. Therefore, members can log in via access control module 118 to access coordinator supplied member offerings 432 and make purchases thereof via transaction module 116. In turn, transaction module 116 can make charges directly to credit lines 124 of the members 202. Once logged in, members 202 can access online base offerings, such as: (a) online workspace, data storage, and utilities; (b) account manager expertise; and/or (c) a posting forum and/or chat for members 202. Members 202 can also view advertisements for resource provider supplied member offerings 434 and member supplied member offerings 436, follow links to websites of the resource providers 102 and members 202, and make purchases at those websites. It is envisioned that members must employ their credit lines 124 to purchase member offerings 112 online. Likewise, at facility 104, members can be required to employ their credit cards 128 in order to purchase member offerings 112. Therefore, in some embodiments, billing module 130 can scan records of the credit lines 124 periodically in order to analyze in computer memory member transaction activity recorded in response to member 202 transactions with the coordinator 200, with the resource providers 102, and with other members 202.

Billing module 130 can be capable of billing fees, dues, and other charges to members 202 and to resource providers 102. Some types of charges that can be billed to resource providers 102 include per transaction fees for transactions between members 202 and resource providers 102. In the case of financial institution 126 issuing credit cards 128, every transaction that members 202 make can be in some respect a transaction with the financial institution 126. Thus, billing module 130 can bill the financial institution 126 for transactions that occur between members 202 and the coordinator 200, between members 202 and resource providers 102, and between members 202 and other members 202. Additionally, billing module 130 can bill one of resource providers 102 for a percentage of each transaction members 202 make with that one of the resource providers 102. Billing module 130 can also bill members for initial and annual fees and monthly dues, and can make these charges directly to credit lines 128. In order to encourage members 202 to transact, billing module 130 can reward members 202 according to a number and/or total monetary amount of transactions by reducing fees and or dues billed. It is envisioned that these fees and/or dues can be reduced to a level that one or more of members 202 pay no dues, pay no fees, or even receive a credit to their credit lines 124.

One or more account managers 438 can be designated to assist specific members 202. The account managers 438 can have offices at the facility 104, and can employ manager interface 132 to enroll new members 202 at the facility 104 and interface with existing members 202 at the facility 104. If an account manager 438 knows that one or more of members 202 has made efforts to transact, but had poor success, it is envisioned that the manager 438 can employ manager interface 132 to access billing module 130 and reduce fees and/or dues for the members 202. It is also envisioned that members 202 who enroll online can also select a local facility 104 and be assigned to an account manager 438 at the selected facility 104. Members 202 can then contact and interface with their account managers 438 by telephone, email, online chat, or by visiting their local facility 104. Account managers 438 can be trained to assist members 202 in setting up and growing their businesses, in selecting member offerings 112, and in obtaining resources needed by members 202 that are not included in member offerings 112. It is envisioned that some managers 438 can have varying levels of expertise regarding different types of businesses, and therefore be assigned to members 202 based on member business types.

It is envisioned that the public areas 106A of facility 104 can attract members of the public 208, thus attracting both potential members 202 and potential clientele for existing members 202. The member areas 108A of the facility 104 can be adjacent to the public areas 106A. Access to the member areas 108A from the public areas 106A can be secured by reception 404 in the member areas, and reception 404 can be utilized to receive clientele of members 202 and to provide information to the public 208 about membership. It is envisioned that advertisements 440 can be located in public areas 106A to provide information about public offerings, base offerings, and member offerings. Other features of the public areas 106A can include dining facilities, restroom facilities, and a quiet room.

For the coordinator 200, the procedures of enrolling and servicing members 202 and engaging and servicing resource providers 102 can involve categorizing the members 202 and the resource providers 102. For example, members 202 can be classified as startups 210, entrepreneurs 212, and small businesses 214 based on company scale. Resource providers can also be categorized in part by scale (e.g., local, state, national, international, etc.), but can also select whether to participate as a tier one 216, tier two 218, or tier three 220 resource provider. In both cases, the amounts billed and types of services obtained can vary by category or tier.

Managers 438 can assess a potential member's scale to determine the appropriate category. The amount members 202 are charged for initial and annual fees and monthly dues can vary by member category. Also, the base services received by members 202 can vary by member category. Table 1 presents an example member fee structure, while Tables 9-20 supply examples of members 202 for some embodiments. Table 20 presents base services by member category for some embodiments.

TABLE 9
Member Fee Structure

| | Company Scale | | | | | |
|---|---|---|---|---|---|---|
| | Startup | | Entrepreneur | | Small Business | |
| | Annual | Monthly | Annual | Monthly | Annual | Monthly |
| Status | Registration | Dues | Registration | Dues | Registration | Dues |

Platinum
Gold
Silver

TABLE 10
Fees Example: Plumber: Start-Up

| | | | Est. | |
|---|---|---|---|---|
| | | Est. One | Monthly | |
| Pillar | Service/Product | Time Fee | Fee | Annualized |
| Coordinator | | $250 | | $250 |
| Base Service | Monthly Dues | | $10 | $120 |
| Coordinator A | Phone | | $20 | $240 |
| La Carte | Receptionist | | | |
| Resource | Business | | $10 | $120 |
| providers | Insurance | | | |
| | Health Insurance | | $30 | $360 |
| | Cell Phone & | $10 | $5 | $70 |
| | Service Plan | | | |
| | Auto Loan | $150 | | $150 |
| | Deposit Accounts | $50 | | $50 |
| | PC | $100 | | $100 |
| Other Members | Book Keeping | | $5 | $60 |
| | Print Business | $10 | | $10 |
| | Cards | | | |
| | Print Brochures | $10 | | $10 |
| | Print Order Forms | $5 | | $5 |
| | Chiropractor | | $2 | $24 |
| | | $585 | $82 | $1,569 |

TABLE 11
Plumber Experience

| | COORDINATOR A | RESOURCE | OTHER |
|---|---|---|---|
| Coordinator | LA CARTE | PROVIDERS | MEMBERS |
| Svc/Prdct | Svc/Product | Svc/Prdct | Svc/Prdct |
| Counsel on | Phone Receptionist | Web Hosting & | Book Keeping |
| Corp Structure | | eMail | |
| Executes entity | | Business | Print Business |
| paperwork | | Insurance | Cards, |
| | | | Brochures, |
| | | | Work Order |
| | | | Forms |
| Design basic | | Health Insurance | Chiropractor |
| branding | | | |
| Setup email | | Cell phone & | |
| | | service plan | |
| Setup basic | | Auto loan for new | |
| website | | truck | |
| Counsel on | | Deposit Accounts | |
| what pc to buy | | | |
| | | PC Purchase | |

TABLE 12
Fees Example: Chiropractor: Small Business

| | | Est. One | Est. | |
|---|---|---|---|---|
| | | Time | Monthly | |
| Pillar | Service/Product | Fee | Fee | Annualized |
| Coordinator | | $250 | | $250 |
| Base Service | Monthly Dues | | $10 | $120 |
| Coordinator A | Freshen Brand | $1,000 | | $1,000 |
| La Carte | Promotion Design | $500 | | $500 |
| | Promotion | $2,000 | | $2,000 |
| | Delivery | | | |
| | Web Site Updates | $500 | | $500 |
| Resource | Advertising | $50 | | $50 |
| providers | in RFT | | | |
| | Cell Phone & | $10 | $5 | $70 |
| | Service Plan | | | |
| | Mastercard | $150 | $5 | $210 |
| Other | Book Keeping | | $5 | $60 |
| Members | Print Business | $10 | | $10 |
| | Cards | | | |
| | Print Brochure | $10 | | $10 |
| | Office Cleaning | | $5 | $60 |
| | Plumber | $5 | | $5 |
| | | $4,485 | $30 | $4,845 |

TABLE 13
Chiropractor Experience:

| Coordinator | Coordinator A LA | RESOURCE | OTHER |
|---|---|---|---|
| BASE | CARTE | PROVIDERS | MEMBERS |
| Svc/Prdct | Svc/Prdct | Svc/Prdct | Svc/Prdct |
| Counsel on Book | Design & Produce | Advertising in | Book |
| Keeping | Promotions (eMail) | Riverfront | Keeping |
| alternatives | Campaign, Print | Times | |
| | Brochures, | | |
| | Advertisements), for | | |
| | New Client | | |
| | Acquisition | | |
| | and Repeat Sales | | |
| Counsel on New | Update Website with | Cell Phone & | Print |
| Client Acquisition | fresh graphics, text | Service Plan | Business |
| and Repeat Sales | and tie in promotions | | Cards, |
| to Existing | | | Brochures |
| Clients | | | |
| Counsel on Brand | New business card | PC Purchase | Office |
| Management | design | | Cleaning |
| | | | Service |
| Counsel on | | Mastercard | Plumber |
| upgrading pc | | Merchant | |
| | | Progarm | |

TABLE 14
Fees Example: Real Estate Agent: Small Business

| | | Est. One | Est. Monthly | |
|---|---|---|---|---|
| Pillar | Service/Product | Time Fee | Fee | Annualized |
| Coordinator | | $250 | | $250 |
| Base Service | | | | |
| | Monthly Dues | | $10 | $120 |
| Coordinator A | Meeting Space | | $10 | $120 |
| La Carte | | | | |
| Resource | Cell Phone & | $10 | $5 | $70 |
| providers | Service Plan | | | |
| | Car Rental | | $20 | $240 |
| Other Members | Cleaning | | $5 | $60 |
| | Services | | | |
| | Plumber | | $10 | $120 |
| | Pet care | | $10 | $120 |
| | Lawn care | | $20 | $240 |
| | Auto Broker | $250 | | $250 |
| | | $510 | $90 | $1,590 |

TABLE 15
Real Estate Agent Experience

| | Coordinator | | |
|---|---|---|---|
| Coordinator | A LA | RESOURCE | OTHER |
| BASE | CARTE | PROVIDERS | MEMBERS |
| Svc/Prdct | Svc/Prdct | Svc/Prdct | Svc/Prdct |
| Counsel on | Meeting Space | Cell Phone & | Cleaning Services |
| Customer | | Service Plan | for his listings |
| Segmentation | | | |
| and Brand | | | |
| Creation & | | | |
| Development | | | |
| Restaurant | | Car Rental (for | Plumber |
| Reservations | | out of town | |
| | | buyers) | |
| Notary Services | | | Pet Care (for his |
| | | | clients who travel) |
| | | | Lawn Care (for his |
| | | | clients) |
| | | | Attorney |
| | | | Auto Broker |

TABLE 16
Fees Example: IT Consultant: Entrepreneur

| | | | Est. | |
|---|---|---|---|---|
| | | Est. One | Monthly | |
| Pillar | Service/Product | Time Fee | Fee | Annualized |
| Coordinator | | $250 | | $250 |
| Base Service | Monthly Dues | | $10 | $120 |
| Coordinator | Phone Receptionist | | $20 | $240 |
| A La Carte | Meeting Space | | $10 | $120 |
| | Book Keeping | | $100 | $1,200 |
| Resource | Business Insurance | | $10 | $120 |
| providers | Health Insurance | | $30 | $360 |
| | Cell Phone & | $10 | $5 | $70 |
| | Service Plan | | | |
| | PC | $100 | | $100 |
| | Wireless | $50 | | $50 |
| | Networking | | | |
| | High-Speed Internet | | $5 | $60 |
| | Web Hosting | | $10 | $120 |
| | & eMail | | | |
| | Deposit Accounts | $50 | | $50 |
| Other | Attorney Contract | | $5 | $60 |
| Members | Dev | | | |
| | Graphic Design | $10 | | $10 |
| | Print Business Cards | $10 | | $10 |
| | | $480 | $205 | $2,940 |

TABLE 17
IT Consultant Experience

| Coordinator | Coordinator A | RESOURCE | OTHER |
|---|---|---|---|
| BASE | LA CARTE | PROVIDERS | MEMBERS |
| Svc/Prdct | Svc/Prdct | Svc/Prdct | Svc/Prdct |
| Counsel on | Receptionist | Cell Phone & | Attorney, Contract |
| Corp Law, | | Service Plan | Development |
| Contracts | | | |
| Notary | Meeting Space | PC Purchase | Graphic Designers |
| Services | | | |
| | Bookkeeping | Wireless | Print Business Cards |
| | | Networking | |
| | | Hardware | |
| | | Purchase | |
| | | High-Speed | |
| | | Internet | |
| | | Website Hosting | |
| | | & email Services | |
| | | for Clients | |
| | | Deposit Accounts & | |
| | | Services | |
| | | Insurance: health, | |
| | | business | |

TABLE 18
Fees Example: Attorney:Small Business

| | | | Est. | |
|---|---|---|---|---|
| | | Est. One | Monthly | |
| Pillar | Service/Product | Time Fee | Fee | Annualized |
| Coordinator | | $250 | | $250 |
| Base Services | | | | |
| | Monthly dues | | $10 | $120 |
| Coordinator A | | | | |
| La Carte | | | | |
| | None | | | |
| Resource | Health | $30 | $10 | $150 |
| providers | Insurance | | | |
| | Business | $20 | $2 | $44 |
| | Insurance | | | |
| | Disability | $5 | $2 | $29 |
| | Insurance | | | |
| | Cell Phone & | $10 | $2 | $70 |
| | Service Plan | | | |
| | Letter of Credit | $50 | | $50 |
| | Deposit | $20 | | $20 |
| | Accounts | | | |
| | Corporate | $10 | | $10 |
| | Credit Cards | | | |
| | Copier/Fax | $100 | | $100 |
| | Machine | | | |
| Other | Real Estate | $200 | | $200 |
| Members | Agent | | | |
| | Chiropractor | | $5 | $60 |
| | Messenger | | $10 | $120 |
| | Service | | | |
| | | $695 | $44 | $1,223 |

TABLE 19
Attorney Experience

| Coordinator | Coordinator A | RESOURCE | OTHER |
|---|---|---|---|
| BASE | LA CARTE | PROVIDERS | MEMBERS |
| Svc/Prdct | Svc/Prdct | Svc/Prdct | Svc/Prdct |
| Counsel on | Meeting space | Cell Phone & | Real Estate Agent |
| Customer | | Service Plan | |
| Segmentation | | | |
| and Brand | | | |
| Creation & | | | |
| Development | | | |
| Restaurant | | Copier/Fax | Chiropractor |
| Reservations | | purchase | |
| Notary | | Bank: deposit | Messenger Service |
| Services | | accounts, | |
| | | corporate credit | |
| | | cards, Letter of | |
| | | Credit | |
| | | Insurance: Health, | |
| | | Disability, | |
| | | Business | |

### Base Services

TABLE 20
Base Services by Member Category

| | START UP | ENTREPRENEUR | SMALL BUSINESS |
|---|---|---|---|
| Personal & | Access to a | Access to a | Access to a resource |
| Family | resource who will | resource who will | who will help in any |
| Services | help in any and all | help in any and all of | and all of the offered areas |
| | of the offered areas | the offered areas | |
| Accounting | Counsel and | Counsel and | Counsel on methods |
| | assistance to | assistance to | to optimize book |
| | design and | design and | keeping, a/p, a/r, |
| | establish the | establish the | payroll0 |
| | company's books | company's books | |
| | Counsel and | Counsel and | |
| | assistance to | assistance to | |
| | understand and | understand and | |
| | manage payment of | manage payment of | |
| | State & Federal | State & Federal | |
| | taxes | taxes | |
| Office | Access to the | Access to the | Access to the |
| Support | COORDINATOR | COORDINATOR | COORDINATOR |
| | Center (meeting | Center (meeting | Center (meeting |
| | rooms, hoteling | rooms, hoteling | rooms, hoteling |
| | space) and no cost | space) and no cost | space) and no cost |
| | use of all | use of all | use of all equipment |
| | equipment | equipment | Free Notary |
| | Free Notary | Free Notary | |
| Technology | No cost counsel | No cost counsel | No cost counsel and |
| | and assistance in | and assistance in | assistance in |
| | purchasing | purchasing | purchasing |
| | hardware, software | hardware, software | hardware, software |
| | No cost Tech | No cost Tech | No cost Tech |
| | Support for PCs | Support for PCs | Support for PCs |
| | Setup email | Setup email | |
| Marketing | Company Naming | Company Naming | Counsel and |
| | Logo design & | Logo design & | assistance to |
| | development | development | understand how to |
| | Basic website | Basic website | segment and reach |
| | design & setup | design & setup | customers |
| | Design Business | Design Business | Counsel and |
| | cards | cards | assistance on brand |
| | | Counsel and | management |
| | | assistance to | |
| | | understand how to | |
| | | segment and reach | |
| | | customers | |
| | | Design support | |
| Legal | Counsel and | Counsel and | Counsel and |
| | assistance to | assistance to | assistance regarding |
| | determine optimal | determine optimal | Trademark |
| | corp structure, | corp structure, | Counsel and |
| | registrations to do | registrations to do | assistance to |
| | business, secure | business, secure | understand needs |
| | EIN | EIN | and work with Legal |
| | Counsel and | Counsel and | Svcs- |
| | assistance | assistance | Members/Resource |
| | regarding | regarding | providers |
| | Trademark | Trademark | |
| Insurance | Counsel and | Counsel and | Counsel and |
| | assistance to | assistance to | assistance to |
| | understand needs | understand needs | understand needs |
| | and work with | and work with | and work with |
| | Resource providers | Resource providers | Members/Resource |
| | | | providers |
| Finance | Counsel and | Counsel and | Counsel and |
| | assistance to | assistance to | assistance to |
| | understand needs | understand needs | understand needs |
| | and work with | and work with | and work with |
| | Resource providers | Resource providers | Resource providers |
| Buying | Access to special | Access to special | Access to special |
| Power | pricing via | pricing via | pricing via |
| | Members/Resource | Members/Resource | Members/Resource |
| | providers | providers | providers |
| Community | Discounts on food | Discounts on food | Discounts on food & |
| Center | & beverages | & beverages | beverages |
| | Free computer | Free computer | Free computer |
| | rental | rental | rental |

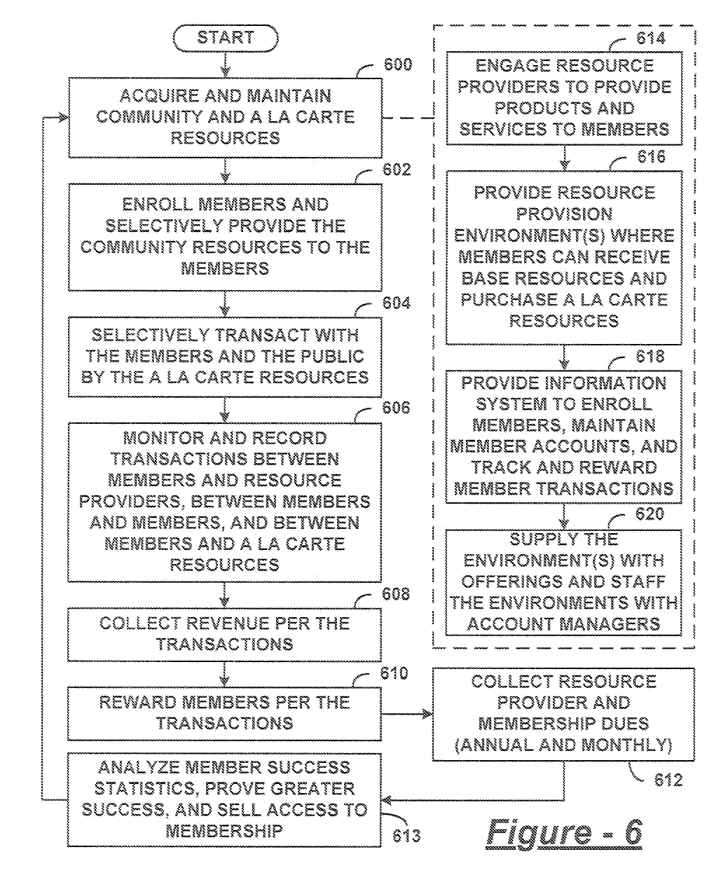

Turning now to FIG. 6, a resource provision coordination method can start with acquiring and maintaining community and a la carte resources at step 600. Next, members are enrolled and selectively provided community resources 602. Transactions are selectively performed with members of the public and with members by the a la carte resources at step 604. Transactions between members and the coordinator, between members and resource providers, and between members and members are monitored and recorded at step 606. Revenue can be collected from the resource providers according to the transactions at step 608. Members are rewarded per the transactions at step 610, and dues, including initial and annual fees and monthly dues, are collected from members and resource providers at step 612.

Member success statistics are analyzed and compared with those indicating success of similar, non-member businesses at step 613. Types of data analyzed can include growth statistics, sustainability, number of employees, and other measurable phenomenon, thus proving that members are less likely to default on business loans than their non-member counterparts. In other words, the data is used to prove that member businesses have greater success than their non-member counterparts. This increased likelihood to succeed is of value to resource providers. As a result, access to the membership market can be sold even more effectively to resource providers at step 600. Thus, the available resources increase, the membership grows, the members' businesses become even more successful compared to non-member businesses, and the entire entity dynamic synergistically expands and enhances over time.

Acquiring and maintaining the a la carte resources at step 600 can include engaging resource providers to provide products and services to members at step 614. It can also include maintaining a coordinated resource provision environment at step 616, such as a facility or website at which the public can access public offerings while members can receive base offerings and access both public and member offerings. It can further include providing an information system at step 618 to enroll members, maintain member accounts, and track and reward member transactions. It can still further include stocking and staffing the environment with the offerings at step 620.

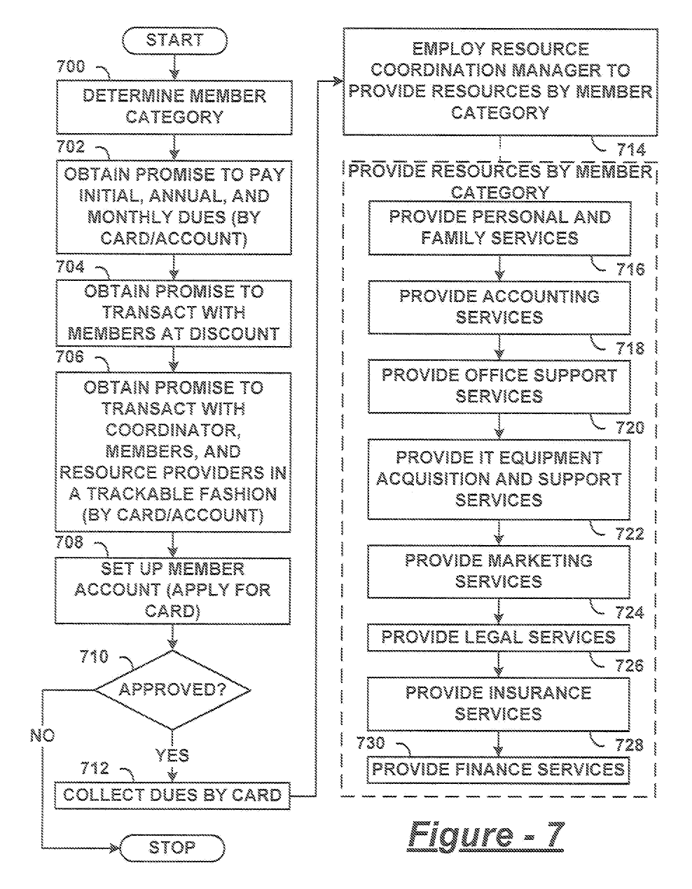

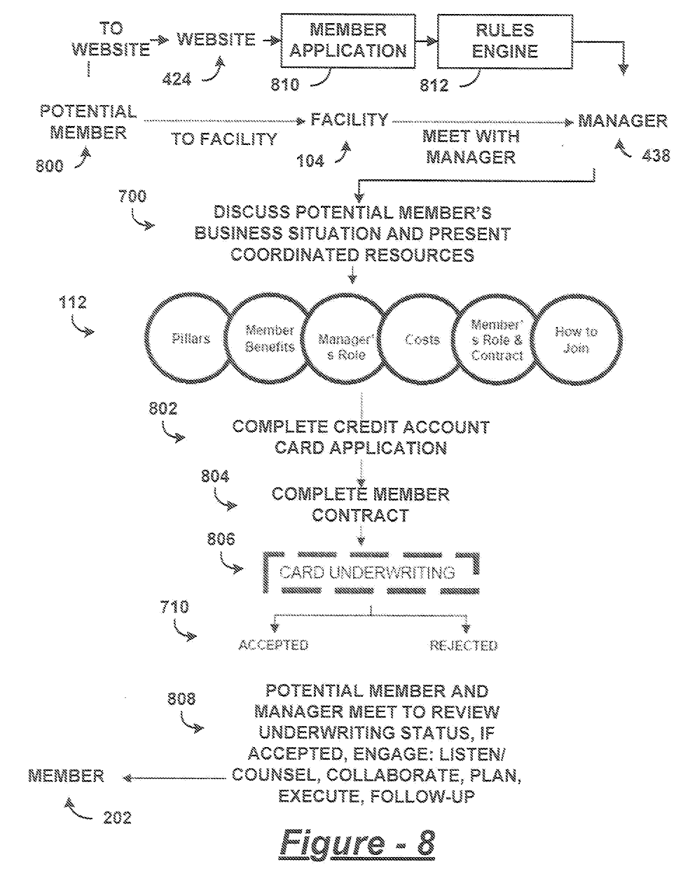

Turning now to FIGS. 7 and 8 and referring generally thereto, enrolling and interacting with members can begin, for example, when a potential member 800 goes to a facility 104 of the coordinator and meets with an account manager 438. The manager 438 can then determine a member category at step 700 by discussing the potential member's business situation while presenting the base offerings and member offerings 112 to the potential member. While enrolling the potential member 800, the manager 438 can help the potential member complete a credit card application at 802, and complete a member contract at 804. As part of the member contract, a promise can be obtained at step 702 from the potential member to pay initial, annual and monthly dues, preferably via the credit card. Additional promises can also be obtained at steps 704 and 706 to transact with other members at a discount, and to transact with other members, with resource providers, and with the coordinator in a trackable fashion, such as by using the card. Next, the member account can be set up at step 708 with a flag set to indicate status pending card approval. Card underwriting can also be performed at step 806 and, if the card application is approved at decision step 710, then dues can immediately be charged to the card at step 712. In any event, the manager 438 can meet with the potential member 800 at 808 to discuss underwriting status. If the card application is accepted, the potential member can become a member 202, and the manager 438 can immediately begin to provide resources to the member 202 as appropriate for the member category. Thus, the manager 438 can engage, listen, collaborate, plan, execute, and follow-up to ensure the member's needs are met for doing business. The member 202 can receive personal and family services at step 716, accounting services at step 718, office support services at step 720, IT equipment acquisition and support services at step 722, marketing services at step 724, legal services at step 726, insurance services at step 728, and finance services at step 730.

In some embodiments, the potential member 800 can make initial contact with the manager 438 by entering through the website 424. In this case, the member can interact with a portion of the enrollment module by filling out an electronic application 810 that is processed according to business rules of rule engine 812 to set up a telephone call, chat session, or personal appointment with the manager 438 local to the potential member 800. Then, the manager 438 can consult with the potential member and assist them in completing the credit card application and member contract. It is envisioned that that the credit application and contract can, in some embodiments, be completed online by the potential member 800. Also, in some embodiments, the involvement of the manager 438 during the credit application and contract completion processes can be optional. In other words, in some embodiments the online application can proceed directly to submission of the credit application and completion of the contract without involvement of the manger 438, and the initial meeting with the manager 438 can occur for the first time at 808. It should yet further be readily understood that contracts and card applications can be mailed or otherwise communicated to potential members, and the potential members 800 can respond to received instructions to consult with a manager 438 or proceed autonomously with the enrollment process.

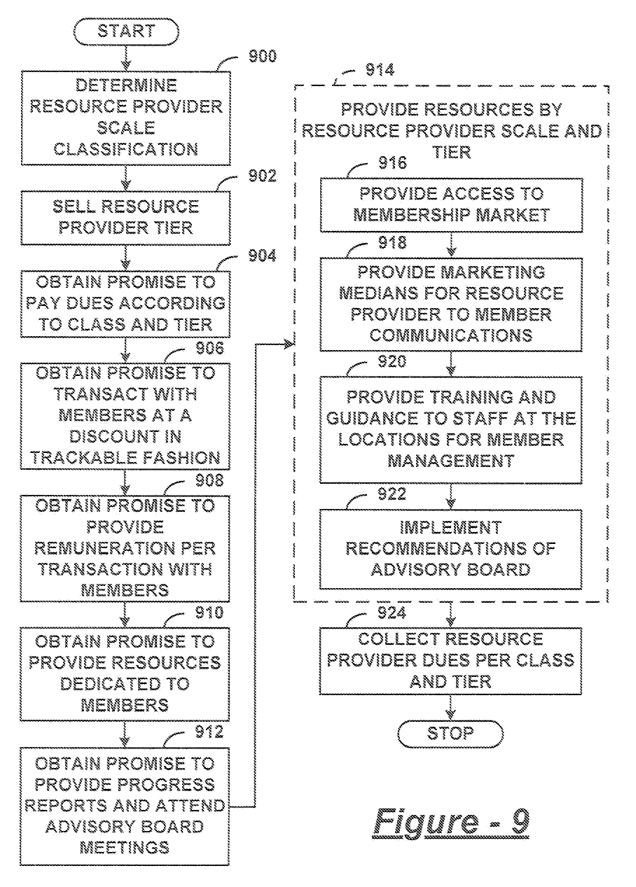

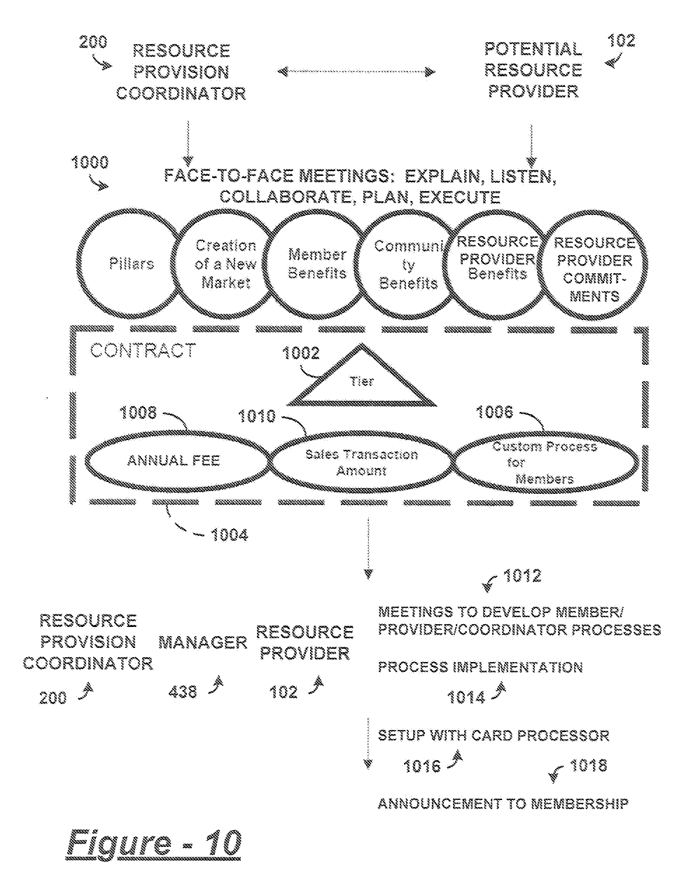

Turning now to FIGS. 9 and 10 and referring generally thereto, engaging and interacting with resource providers can begin, for example, when the resource provision coordinator 200 approaches the resource provider 102, or when the resource provider 102 approaches the coordinator 200. The coordinator 200 and the resource provider 102 can have face to face meetings at 1000 to explain, listen, collaborate, plan, and execute provision of resources to members. The coordinator 200 can recognize the resource provider scale at step 900, and the resource provider can select a tier 1002 at step 902. As part of the contract 1004 between the resource provider 102 and coordinator 200, the resource provider 102 can be required to provide a custom process for members 1006. Additionally, an annual fee 1008 and sales transaction amount 1010 are determined by the resource provider scale and tier. Therefore, various promises can be obtained in steps 904-912, including: (a) a promise to pay dues according to class and tier; (b) a promise to transact with members at a discount in a trackable fashion such as via the cards; (c) a promise to provide remuneration per transactions with members, (d) a promise to provide resources dedicated to members; and (e) a promise to provide progress reports and attend advisory board meetings. Then, it is possible to provide resources needed by the resource providers at step 914, and to collect resource provider dues per scale classification and tier at step 924. Providing resources at step 914 can include: (a) providing access at step 916 to the membership market; (b) providing marketing medians at step 918 for resource provider to member communications; (c) providing training and guidance at step 920 to staff at facilities for member management; (d) and implementing recommendations at step 922 of an advisory board made up of resource providers. The coordinator 200, managers 438, and resource providers 102: (a) have meetings at 1012 to develop member/provider/coordinator processes; (b) implement processes at 1014; (c) setup the resource providers at 1016 with the credit card processor for billing; and (d) announce/advertise the resource provider and offerings to members at 1018.

It is envisioned that, since access to the membership can become more valuable as the membership size increases, these fees can vary by membership size. Some examples of fees in some embodiments are supplied in the tables below. In these tables, the Benefits are: (A) (i) Provides Exclusive positioning within all Non-Coordinator Corp Only Marketing materials (print, web, eMail, newsletters); (ii) Provides One Seat on the Resource provider Advisory Committee; and (iii) Provides some exclusivity relative to other Resource providers within the specific industry/sector; (B) (i) Provides position within select Coordinator Resource provider Marketing materials secondary to Tier One Resource providers (print, web); and (ii) Resource provider Advisory Committee attendance will be upon Invitation (from Coordinator Leader-ship) only; and (C) (i) Provides positioning within select Coordinator Resource provider Marketing materials secondary to Tier Two Resource providers (print, web); and (ii) Resource provider Advisory Committee attendance will be upon invitation (from Coordinator Leadership) only. Also, these tables report on Resource Provider (RP) market share (MS) by tier and class over a course of years as membership grows for an example set of banks 1-9.

### Resource Provider Annual Agreement

| | | | | | Classification | | | |
|---|---|---|---|---|---|---|---|---|
| | | | National | | State | | Local | |
| | | | Annual | | Annual | | Annual | |
| | | Membership | Agreement | | Agreement | | Agreement | |
| Tier | Benefits | Volume | Fee | Sales | Fee | Sales | Fee | Sales |
| Tier 1 | A | 0–1,000 | 80,000 | $xx | 56,000 | $xx | 40,000 | $xx per |
| | | | | per | | per | | transaction |
| | | | | transaction | | transaction | | negotiated |
| | | | | negotiated | | negotiated | | |
| | | 1,001–10,000 | 160,000 | | 112,000 | | 80,000 | |
| | | 10,001–50,000 | 240,000 | | 168,000 | | 120,000 | |
| | | 50,001> | 400,000 | | 280,000 | | 200,000 | |
| Tier 2 | B | 0–1,000 | 40,000 | $xx | 28,000 | $xx | 20,000 | $xx/per |
| | | | | per | | per | | transaction |
| | | | | transaction | | transaction | | negotiated |
| | | | | negotiated | | negotiated | | |
| | | 1,001–10,000 | 80,000 | | 56,000 | | 40,000 | |
| | | 10,001–50,000 | 120,000 | | 84,000 | | 60,000 | |
| | | 50,001> | 200,00 | | 140,000 | | 100,000 | |
| Tier 3 | C | 0–1,000 | 20,000 | $xx | 14,000 | $xx | 10,000 | $xx per |
| | | | | per | | per | | transaction |
| | | | | transaction | | transaction | | negotiated |
| | | | | negotiated | | negotiated | | |
| | | 1,001–10,000 | 40,000 | | 28,000 | | 20,000 | |
| | | 10,001–50,000 | 60,000 | | 42,000 | | 30,000 | |
| | | 50,001> | 100,000 | | 70,000 | | 50,000 | |

### Banks

### Estimated Revenue

| | | | classification | | | | | |
|---|---|---|---|---|---|---|---|---|
| | | | National | | State | | Local | |
| | | MS | Annual | | Annual | | Annual | |
| Tier | RP | 100% | agreement | Sales | agreement | Sales | agreement | Sales |

Year 1

| | | | | | | | | |
|---|---|---|---|---|---|---|---|---|
| Tier 1 | 1 | 20% | $80,000 | $18,167 | | | | |
| | 2 | 22% | | | $56,000 | $19,984 | | |
| | 3 | 19% | $80,000 | 17,259 | | | | |
| Tier 2 | 4 | 7% | 40,000 | 6,358 | | | | |
| | 5 | 9% | 40,000 | 8,175 | | | | |
| | 6 | 12% | | | 28,000 | 10,900 | | |
| Tier 3 | 7 | 4% | | | 14,000 | 3,633 | | |
| | 8 | 3% | 40,000 | 2,725 | | | | |
| | 9 | 4% | | | | | 10,000 | 3,633 |

Estimated Sales

| | Yr. 1 | Yr. 2 to 3 | Yr. 4> |
|---|---|---|---|
| (No. of Transactions) | 4.542 | 40.864 | 87.520 |

| | |
|---|---|
| Annual Agreements | $388,000 |
| Penetration | 50% |
| Sales | $90,836 |
| Total | $458,836 |
| Sales Fee | $20 |

| classification | | |
|---|---|---|
| National | State | Local |

| | | | | | | | | |
|---|---|---|---|---|---|---|---|---|
| | | MS | Annual | | Annual | | Annual | |
| Tier | RP | 100% | agreement | Sales | agreement | Sales | agreement | Sales |

Year 2 to 3

| | | | | | | | | |
|---|---|---|---|---|---|---|---|---|
| Tier 1 | 1 | 20% | 160,000 | 163,456 | | | | |
| | 2 | 22% | | | 112,000 | 179,802 | | |
| | 3 | 19% | 160,000 | 155,283 | | | | |
| Tier 2 | 4 | 7% | 80,000 | 57,210 | | | | |
| | 5 | 9% | 80,000 | 73,555 | | | | |
| | 6 | 12% | | | 56,000 | 98,074 | | |
| Tier 3 | 7 | 4% | | | 28,000 | 32,691 | | |
| | 8 | 3% | 40,000 | 24,518 | | | | |
| | 9 | 4% | | | | | 20,000 | 32,691 |
| | | Sub- | $520,000 | $474,023 | $196,000 | $310,567 | $20,000 | $32,691 |
| | | Totals | | | | | | |

Estimated Sales

| | Yr. 1 | Yr. 2 to 3 | Yr. 4> |
|---|---|---|---|
| (No. of Transactions) | 4.542 | 40.864 | 87.520 |

| | |
|---|---|
| Annual Agreements | $736,000 |
| Penetration | 50% |
| Sales | $817,281 |
| Total | $1,553,281 |
| Sales Fee | $20 |

| | | | classification | | | | | |
|---|---|---|---|---|---|---|---|---|
| | | | National | | State | | Local | |
| | | MS | Annual | | Annual | | Annual | |
| Tier | RP | 100% | agreement | Sales | agreement | Sales | agreement | Sales |

Year 4

| | | | | | | | | |
|---|---|---|---|---|---|---|---|---|
| Tier 1 | 1 | 20% | 240,000 | 350,081 | | | | |
| | 2 | 22% | | | 168,000 | 385,089 | | |
| | 3 | 19% | 240,000 | 332,577 | | | | |
| Tier 2 | 4 | 7% | 120,000 | 122,528 | | | | |
| | 5 | 9% | 120,000 | 157,536 | | | | |
| | 6 | 12% | | | 28,000 | 210,049 | | |
| Tier 3 | 7 | 4% | | | 14,000 | 70,016 | | |
| | 8 | 3% | 60,000 | 52,512 | | | | |
| | 9 | 4% | | | | | 30,000 | 70,016 |
| | | Sub- | $780,000 | $1,015,235 | $294,000 | $665,154 | $30,000 | $70,016 |
| | | Totals | | | | | | |

Estimated Sales

| | Yr. 1 | Yr. 2 to 3 | Yr. 4> |
|---|---|---|---|
| (No. of Transactions) | 4.542 | 40.864 | 87.520 |

| | |
|---|---|
| Annual Agreements | $1,104,000 |
| Penetration | 50% |
| Sales | $1,750,405 |
| Total | $2,854,405 |
| Sales Fee | $20 |

What is claimed is:

1. A resource provision coordination system, comprising:
an enrollment module enrolling members who wish to transact with their clientele, including obtaining promises of members to pay fees in exchange for membership, approving members for financing of credit lines, and creating member accounts having the credit lines associated therewith in computer readable memory;
a datastore of member offerings including resources supplied by engaged resource providers and offered to the members at least one of exclusively or according to terms not available to non-members;
a coordinated resource provision environment providing community and a la carte resources at least to the members, wherein: (a) the community resources include at least base offerings at least some of which are supplied to members by a resource provision coordinator in exchange for the fees; and (b) the a la carte resources include at least the member offerings.

2. The system of claim 1, further comprising a billing module rewarding the members for employing the credit lines to transact at least one of with the resource providers, with one another, or with the resource provision coordinator.

3. The system of claim 2, wherein said billing module debits the dues to the credit lines, and said billing module rewards the members by at least one of reducing the fees or applying credits to the credit lines.

4. The system of claim 1, further comprising a billing module employing electronic records of the credit lines of the members to track transactions of the members with the resource providers, and collecting revenue from the resource providers per the transactions of the members with the resource providers.

5. The system of claim 1, further comprising a billing module periodically billing the resource providers for fees owed by the resource providers to the coordinator, wherein the resource providers pay the fees to the coordinator in exchange for access to the members.

6. The system of claim 5, wherein the resource providers purchase from the coordinator different levels of access to the members, and said billing module bills different categories of the resource providers different fees according to their levels of access to the members.

7. The system of claim 5, wherein said billing module increases the fees billed to the resource providers as a membership comprised of the members grows.

8. The system of claim 1, wherein said coordinated resource provision environment includes at least one facility having a member area and a public area.

9. The system of claim 8, wherein the member area includes an office environment presenting base offerings that include office space, office equipment, meeting space, and reception.

10. The system of claim 8, wherein the public area includes a publicly accessible cafe environment presenting a la carte resources that include refreshment.

11. The system of claim 1, wherein said coordinated resource provision environment includes at least one website having a member area and a public area.

12. The system of claim 11, wherein the member area includes member account access and at least one of: (a) links to websites of resource providers permitting member purchase of at least some of the member offerings by using the credit lines to complete online transactions; or (b) an electronic storefront permitting member purchase of at least some of the member offerings by using the credit lines to complete online transactions.

13. The system of claim 11, wherein the public area includes advertisements informing potential members of the base offerings, and a user interface allowing the potential members to interact with said enrollment module.

14. The system of claim 11, wherein the public area includes links to member websites.

15. The system of claim 1, wherein the base offerings include expertise and attention of account managers trained to assist members by counseling the members and collaborating with the members to grow businesses of the members.

16. The system of claim 15, wherein said account managers categorize potential members according to their needs for different offerings, and said enrollment module enrolls different categories of the members at different fees.

17. The system of claim 1, wherein said enrollment module enrolls the members across industries and obtains promises from the members to discount at least one of their products or services to other members.

18. The system of claim 1, wherein said enrollment module obtains promises from the members to employ the credit lines when transacting at least one of with the resource providers, with one another, or with the resource provision coordinator.

19. The system of claim 1, wherein said coordinated resource provision environment provides resources to members, including at least one of:
(a) accounting services;
(b) personal and family services;
(c) banking and finance services;
(d) insurance coverage services;
(e) legal services;
(f) marketing services; or
(g) technology product acquisition and support services.

20. The system of claim 1, wherein said resource provision environment includes:
a public area presenting public offerings for purchase by at least non-members to attract potential members and their clientele; and
a member area presenting the base offerings and the member offerings to the members.

21. A resource provision coordination method, comprising:
enrolling members who wish to transact with their clientele, including obtaining promises of members to pay fees in exchange for membership, approving members for financing of credit lines, and creating member accounts having the credit lines associated therewith in computer readable memory;
offering resources supplied by engaged resource providers to the members at least one of exclusively or according to terms not available to non-members;
maintaining a coordinated resource provision environment providing community and a la carte resources at least to the members, wherein: (a) the community resources include at least base offerings supplied to members at least by a resource provision coordinator in exchange for the fees; and (b) the a la carte resources include at least the member offerings.

22. The method of claim 21, further comprising rewarding the members for employing the credit lines to transact at least one of with the resource providers, with one another, or with the resource provision coordinator.

23. The method of claim 22, further comprising:
debiting the dues to the credit lines; and
rewarding the members by at least one of reducing the fees or applying credits to the credit lines.

24. The method of claim 21, further comprising employing electronic records of the credit lines of the members to track transactions of the members with the resource providers, and collect revenue from the resource providers per the transactions of the members with the resource providers.

25. The method of claim 21, further comprising periodically billing the resource providers for fees owed by the resource providers to the coordinator, wherein the resource providers pay the fees to the coordinator in exchange for access to the members.

26. The method of claim 25, further comprising billing different categories of the resource providers different fees according to their levels of access to the members, wherein the resource providers purchase from the coordinator different levels of access to the members.

27. The method of claim 25, further comprising increasing the fees billed to the resource providers as a membership comprised of the members grows.

28. The method of claim 21, wherein said coordinated resource provision environment includes at least one facility having a member area and a public area.

29. The method of claim 28, wherein the member area includes an office environment presenting base offerings that include office space, office equipment, meeting space, and reception.

30. The method of claim 28, wherein the public area includes a publicly accessible cafe environment presenting a la carte resources that include refreshment.

31. The method of claim 21, wherein said coordinated resource provision environment includes at least one website having a member area and a public area.

32. The method of claim 31, wherein the member area includes member account access and at least one of: (a) links to websites of resource providers permitting member purchase of at least some of the member offerings by using the credit lines to complete online transactions; or (b) an electronic storefront permitting member purchase of at least some of the member offerings by using the credit lines to complete online transactions.

33. The method of claim 31, wherein the public area includes advertisements informing potential members of the base offerings, and a user interface allowing the potential members to interact with said enrollment module.

34. The method of claim 31, wherein the public area includes links to member websites.

35. The method of claim 31, wherein the base offerings include expertise and attention of account managers trained to assist members by counseling the members and collaborating with the members to grow businesses of the members.

36. The method of claim 35, wherein further comprising:
categorizing potential members according to their needs for different offerings; and
enrolls different categories of the members at different fees.

37. The method of claim 31, wherein enrolling the members further includes:
enrolling the members across industries; and
obtaining promises from the members to discount at least one of their products or services to other members.

38. The method of claim 31, wherein enrolling the members further includes obtaining promises from the members to employ the credit lines when transacting at least one of with the resource providers, with one another, or with the resource provision coordinator.

39. The method of claim 31, wherein said coordinated resource provision environment provides resources to members, including at least one of:
(a) accounting services;
(b) personal and family services;
(c) banking and finance services;
(d) insurance coverage services;
(e) legal services;
(f) marketing services; or
(g) technology product acquisition and support services.

40. The method of claim 31, wherein said resource provision environment includes:
a public area presenting public offerings for purchase by at least non-members to attract potential members and their clientele; and
a member area presenting the base offerings and the member offerings to the members.
